(19) United States
(12) Patent Application Publication
(10) Pub. No.: US 2011/0000721 A1
(43) Pub. Date: Jan. 6, 2011

(54) HYBRID PARALLEL LOAD ASSIST SYSTEMS AND METHODS

(75) Inventors: Timothy Hassett, Santa Rosa, CA (US); Mark Hodowanec, Leesburg, VA (US)

Correspondence Address: Polster, Lieder, Woodruff & Lucchesi, L.C., 12412 Powerscourt Dr. Suite 200, St. Louis, MO, 63131-3615, US

(73) Assignee: THERMAL MOTOR INNOVATIONS, LLC, Leesburg, VA (US)

(21) Appl. No.: 12/829,603

(22) Filed: Jul. 2, 2010

Related U.S. Application Data
(60) Provisional application No. 61/270,046, filed on Jul. 2, 2009.

(51) Int. Cl. B60K 6/42

(52) U.S. Cl. 180/65.22; 180/65.21

(57) ABSTRACT

In various embodiments, the present disclosure provides systems and methods for providing electrical powered load assist to an internal combustion engine of vehicle.

### CROSS-REFERENCE TO RELATED APPLICATIONS

This application claims the benefit of U.S. Provisional Application No. 61/270,046, filed on Jul. 2, 2009. The disclosure of the above application is incorporated herein by reference in its entirety.

### FIELD

The present teachings generally relate to hybrid vehicles and more particularly to systems and methods for providing electrical powered load assist to an internal combustion engine of vehicle.

### BACKGROUND

The statements in this section merely provide background information related to the present disclosure and may not constitute prior art.

Plug in Hybrid Electric Vehicles (PHEV) & Extended Range Electric Vehicles (EREV) have existed for a long time. Current development of PHEVs and EREVs is generally dependent on designing a ground up vehicle with the PHEV drivetrain as an integral part of the vehicle. In addition, as the focus of PHEVs is to deliver efficient battery powered propulsion to a vehicle, typical PHEV vehicles are designed to be as small and light as possible. Consequently, PHEVs & EREVs have been design around power dense exotic batteries such as lithium-ion & Nickel Metal hydride.

### SUMMARY

In various embodiments, the present disclosure describes an modular electric motor drive system for a plug-in hybrid electric vehicle (PHEV) or an extended range electric vehicle (EREV), e.g., a sports utility vehicle (SUV), a pickup truck, a medium duty truck, a heavy duty truck, a bus, a military vehicle such as a Humvee, or any other vehicle, that will enable a battery powered electric motor for such a vehicle to provide all electric propulsion power for the vehicle for a limited duration. Utilizing the energy generated by ignition of a few gallons of gasoline or diesel fuel, a battery pack provides stored electrical energy to the electric motor, thereby enabling the electric motor to output work approximately equivalent to the work output by an internal combustion engine (ICE) for a limited duration before needing to be recharged. This fuel savings takes into account the regenerative braking provided when the electric motor functions as a generator. Generally, the size of the battery is related to the size of the vehicle, which in turn is related to the amount of gasoline or diesel fuel that can be saved.

In various embodiments, the present system can be used to convert a non-hybrid vehicle into a PHEV. In such instances, the ICE, e.g., the diesel engine and primary driveline of the vehicle stay entirely intact.

When the battery charge is depleted, the vehicle functions just as it would prior to any PHEV modifications. Even before the battery charge is depleted, it is possible for the ICE to provide power in parallel w/the PHEV system when additional power is required.

Moreover, the presently disclosed PHEV conversion systems and methods are based on modification of new or existing vehicles while fully retaining their original drive trains, i.e., internal combustion engine, transmission, drive shaft, a differential and axle assembly, and, in various 4-wheel drive implementations a transfer case. The key is that the basic platform of the original vehicle is unaltered. Specifically, as described below, there will be minor alteration to some vehicle components, but the basic vehicle platform is unaltered. For examples, axles can be upgraded to handle increased weight, the axle or transmission can be altered to accept a parallel electric power input and other drive components, and batteries and controllers can be altered or upgraded. Otherwise, the vehicle is the same. In various embodiments, the presently disclosed PHEV system is designed as a fully parallel system such that the original drive train can supply 0% to 100% power, and the brakes can provide 0 to 100% braking, all depending on controller settings and the level of driver accelerator/brake activation.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a block diagram of a modular electric motor drive system for use in tandem with an internal combustion engine of a vehicle to provide motive power to a vehicle, in accordance with various embodiments of the present disclosure.

FIG. 2 is a cross-sectional view of a portion of the modular electric motor drive system shown in FIG. 5, in accordance with various embodiments of the present disclosure.

FIG. 3 is a cross-sectional view of a portion of the modular electric motor drive system, shown in FIG. 4, in accordance with various other embodiments of the present disclosure.

FIG. 4 is schematic of the modular electric motor drive system, shown in FIG. 1, in accordance with various other embodiments of the present disclosure.

FIG. 5 is schematic of the modular electric motor drive system, shown in FIG. 1, in accordance with various other embodiments of the present disclosure.

FIG. 6 is a schematic of the modular electric motor drive system, shown in FIG. 1, in accordance with still other embodiments of the present disclosure.

FIG. 7 is a chart illustrating an exemplary PHEV and/or EREV Product Matrix of various vehicles incorporating the modular electric motor drive system shown in FIG. 1, in accordance with various embodiments of the present disclosure.

The several drawings provide a graphical disclosure of various embodiments of the presently disclosed systems and methods.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

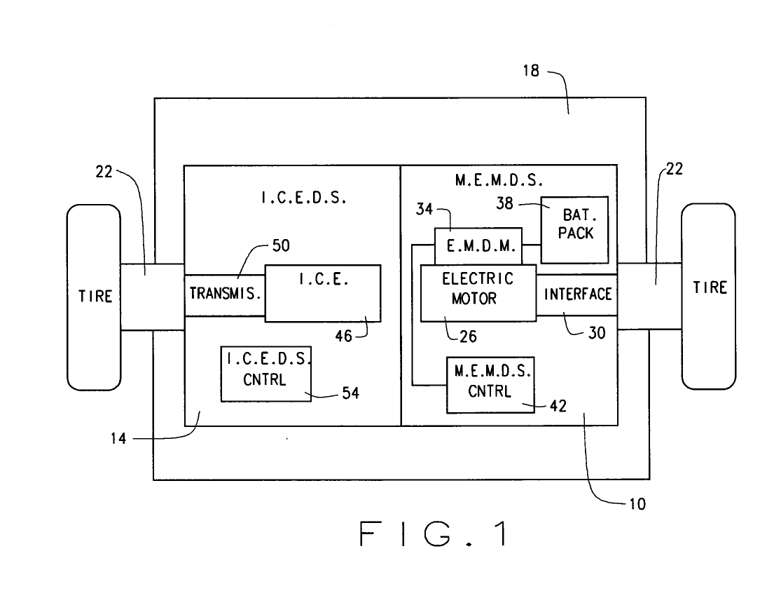

Referring to FIG. 1, the present disclosure provides a modular electric motor drive system (MEMDS) 10 for use in tandem with a known internal combustion engine drive system (ICEDS) 14 of various vehicles 18, e.g., SUVs or pickup trucks, medium duty trucks, heavy duty trucks, buses, military vehicle such as Humvees/HMMWVs, or any other suitable vehicle. In various embodiments, the vehicle 18 is a fully assembled, fully functional and operational preexisting vehicle, and the electric motor is mountable to a portion thereof. More particularly the MEMDS 10 is structure and operable to supplement or assist the ICEDS 14 in providing motive force output to at least a portion of the drive train 22 of the vehicle 18 and, when desired, to replace the ICEDS 14 in providing motive power output to the drive train 22. Hence, the vehicle 18 can be driven utilizing motive force provided entirely by the ICEDS 14, entirely by the MEMDS 14, or driven utilizing motive force provided in part by the ICEDS 14 and in part by the MEMDS 10. The ratio of motive force provided by the ICEDS 14 and the MEMDS 10 can be any desired ratio, based on the operation status of the MEMDS 10, as described further below. As used herein, with regard to the MEMDS 10, the vehicle drive train 22 includes the vehicle 18 transmission, drive shaft, differential and axle assembly, and, in various 4-wheel drive vehicles 18, a transfer case of the vehicle 18.

Generally, the MEMDS 10 includes electric motor 26, e.g. an induction motor, mechanically coupled to a motor gearing/coupling interface (MGCI) 30 mechanically coupled to the vehicle drive train 22, an electric motor variable frequency drive (VFD) module 34 electrically connected to the electric motor 26, a battery pack 38 electrically connected to the VFD module 34 (e.g., an insulated gate bipolar transistor drive module), and a MEMDS controller 42 (i.e., a microprocessor based controller) also electrically connected to the VFD module 34. In various embodiments, the VFD module 34 includes a transformer/rectifier/DC link (not shown) for transforming/converting voltage output from the battery pack 38 to a desired voltage input to the electric motor VFD module 34. The electric motor VFD module 34, which is controlled by the MEMDS controller 42, provides the proper voltage, current, and frequency input to the electric motor 26 The ICEDS 14 generally includes an internal combustion engine (ICE) 46 mechanically coupled to a transmission 50 mechanically coupled to the drive train 22, and an ICEDS controller 54 electrically coupled to the engine 46.

As described herein, in various embodiments, existing internal combustion engine vehicles, such as SUVs or pickup trucks, medium duty trucks, heavy duty trucks, buses, military vehicle such as Humvee/HMMWV, or any other suitable vehicle, can be easily modified to a plug-in hybrid electric vehicle (PHEV) or an extended range electric vehicle (EREV) utilizing the MEMDS 10. Importantly, the MEMDS 10, as described herein, is fully redundant and operates in tandem with the ICE driveline of the vehicle 18 (i.e., the transmission 50 and the drive train 22), and the ICE driveline remains engaged and fully operational presently.

In various embodiments, the electric motor 26 can be a heat pipe cooled induction type traction motor that utilizes heat pipe cooling technology, such as those described in patent applications: Ser. No. 11/765,140, filed Jun. 19, 2007; Ser. No. 12/352,301 filed Jan. 12, 2009; and Ser. No. 12/418,162, filed Apr. 3, 2009, each of which are incorporated herein by reference in their entirety. For example, in various embodiments, the electric motor 26 can have the following specified ratings and features:

Power: 50 Hp continuous, 90 Hp peak

RPM Range: 0-10,000 RPM

Cooling—heat pipe cooled

Weight: 110 lbs.

Dimensions (L×W×H): 13″×8.5″×8.5″

In various exemplary embodiments, e.g., embodiments wherein the vehicle 18 is an SUV or a pickup truck, the electric motor gearing/coupling interface 30 can be structured and operable to function at motor speed ranges of 0 to 10,000 rpms, assuming that the revolution/mile for a typical vehicle, e.g., a SUV or pickup truck, tire is approximately 630 revolutions/mile, and that the axle ratio is 3.42:1. Accordingly, in such instances, the above exemplary specifications will result in a drive shaft of the vehicle 18 spinning at approximately 2155 rpms when the vehicle 18 is moving at approximately 60 mph.

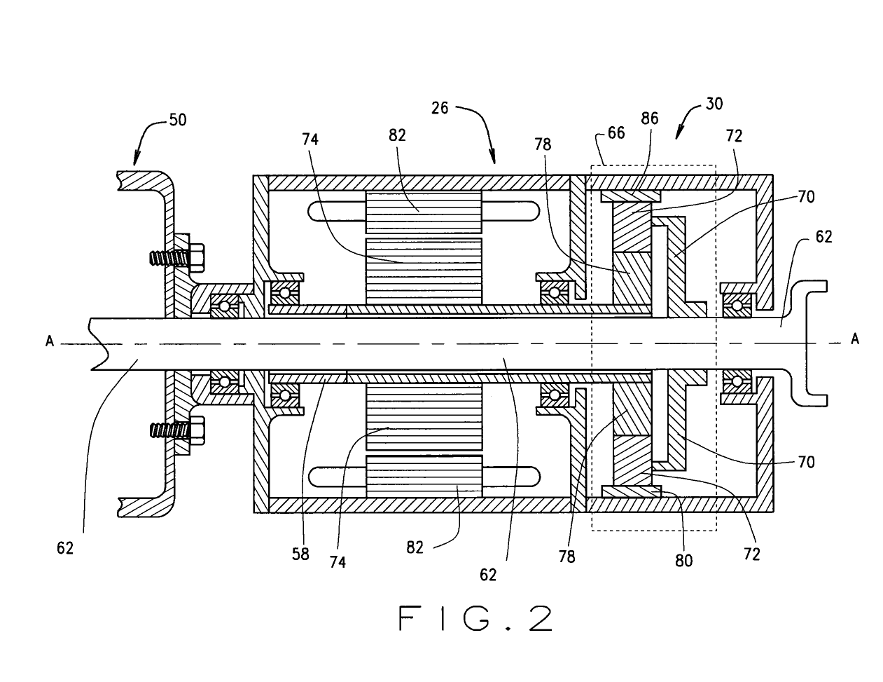

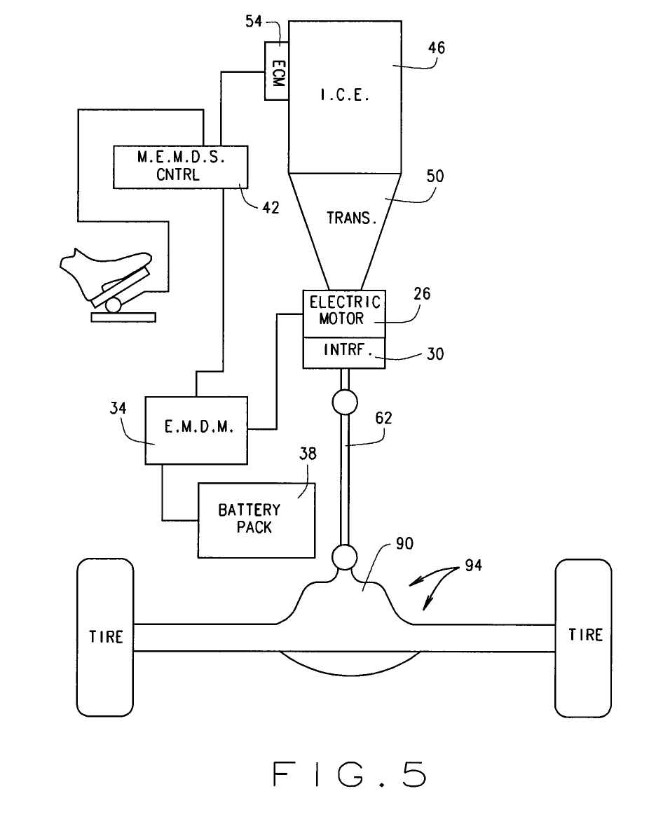

Referring now to FIGS. 2 and 5, in various embodiments, the MEMDS 10 is structured such that the electric motor 26 and electric motor gearing/coupling interface 30 are coupled to a tail end of the vehicle transmission 50 (i.e., the end opposite the ICE) of 2-wheel or 4-wheel drive vehicles 18. In such embodiments, the electric motor 26 includes a hollow motor shaft 58 such that a drive shaft 62 of the vehicle drive train 22, extending from the transmission 50, can be disposed within and extend through the hollow electric motor shaft 58. Additionally, in such embodiments, the electric motor gearing/coupling interface 30 can be mounted to a tail end of the electric motor 26 (i.e., the end opposite transmission 50) and includes an electric motor gearing/coupling interface (EMGCI) planetary gear set 66. Furthermore, in such embodiments, the vehicle transmission drive shaft 62 has planet carrier 70 of the EMGCI planetary gear set 66 directly coupled thereto, and rotationally mounted to distal arms of the planet carrier are planet gears 72.

Additionally, a rotor 74 of the electric motor 26 is directly coupled to hollow electric motor shaft 58 within the motor housing and a sun gear 78 of the EMGCI planetary gear set 66 is directly coupled to a distal end of the hollow electric shaft 58 that extending into the electric motor gearing/coupling interface 30. A stator 82 of the electric motor 26 is mounted to the electric motor housing. The EMGCI planetary gear set 66 further includes a ring gear 86 coupled to the housing of the electric motor gearing/coupling interface 30. Accordingly, during operation of the electric motor 26 rotation of the hollow shaft 58, as driven by rotation of the rotor 74 induced by the stator 82, will drive/rotate the EMGCI sun gear 78 about the drive shaft 62, which in turn will drive the EMGCI planet gears 72 causing the EMGCI planet gears 72 and planet gear carrier 70 to rotate about and a longitudinal axis A of the drive shaft 62 and the hollow shaft 58. Specifically, since the planet gear carrier 70 is directly coupled to the drive shaft 62, the rotation of the planet gear carrier 70 will cause the drive shaft 62 to rotate about the axis A, which will in turn provide torque to wheels of the vehicle 18, via a differential 90 of a respective axle assembly 94 of the vehicle 18.

Thus, the hollow electric motor shaft 58 is always mechanically coupled with the transmission drive shaft 62. Additionally, in various embodiments, the EMGCI planetary gear set 66 of the electric motor gearing/coupling interface 30 provides approximately a 3:1 gear reduction such that the electric motor hollow shaft 58 spins at approximately three times the rotational speed of the transmission drive shaft 62.

Additionally, it should be understood that the EMGCI planetary gear set 66 is described herein only as an exemplary embodiment of the electric motor gearing/coupling interface 30 for providing torque, via operation of the electric motor 26, to the drive shaft 62. Alternatively, the electric motor gearing/coupling interface 30 can include other assemblies or mechanism suitable for providing such torque via operation of the electric motor 26, and remain within the scope of the present disclosure. For example, in various embodiments, the electric motor gearing/coupling interface 30 can include other gearboxes configured using other gear sets, or an internal gear motor to provide torque, via operation of the electric motor 26, to the drive shaft 62.

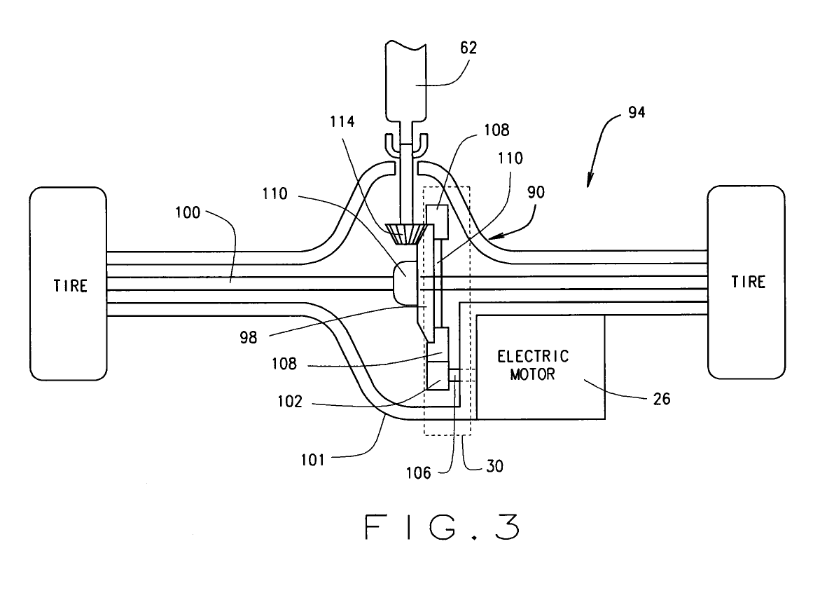

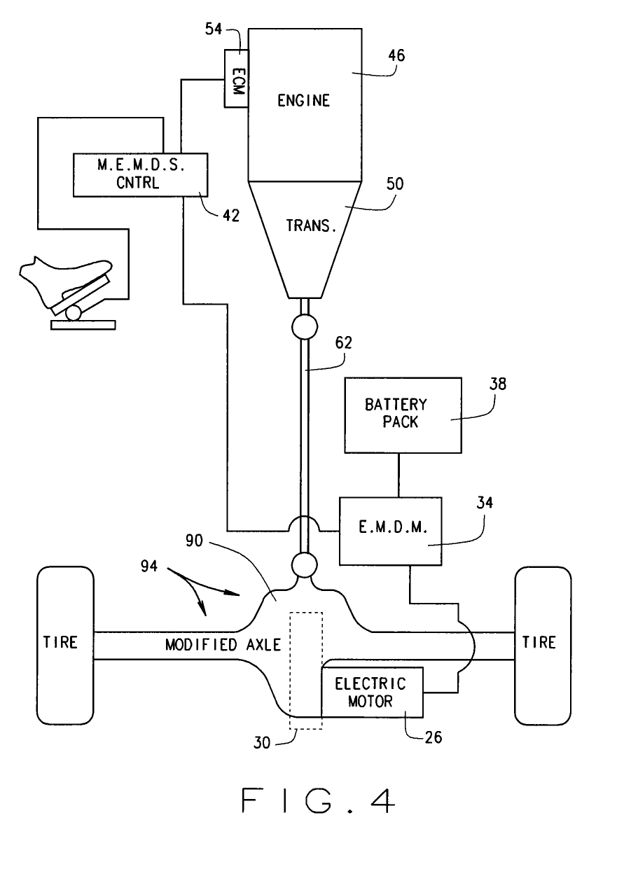

Referring now to FIGS. 3 and 4, the electric motor gearing/coupling interface 30 is disposed within the differential 90 of the vehicle 18 such that the electric motor 26 directly drives a spur ring gear 108 that is mounted on the same differential carrier 110 as a differential hypoid, or ring, gear 98 of the differential 90. The differential carrier 110 is coupled to a drive axle 100 such that it will impart torque on the drive axle 100 via operation of the ICE 46 and/or the electric motor 26, as described below. More specifically, in such embodiments, the electric motor 26 is mounted to a frame of the axle housing 101, and the electric motor gearing/coupling interface 30 is disposed within the differential 90. Particularly, the electric motor gearing/coupling interface 30 includes a spur pinion gear 102 disposed on a distal end of a shaft 106 of the electric motor 26 within the differential 90, and the spur ring gear 108 that is mounted to the same carrier 110 as the hypoid gear 98 within the differential 90. The spur pinion gear 102 is operationally engaged with the spur ring gear 108.

Moreover, the differential hypoid gear 98 is operationally engaged with a pinion gear 114 disposed at a distal end of the vehicle drive train drive shaft 62 such that the rotation of the vehicle drive train drive shaft 62, via the ICE 46, will cause the pinion gear 114 to drive/rotate the hypoid gear 98, differential carrier 110, and the drive axle 100. Additionally, as described above, the spur ring gear 108 of the electric motor gearing/coupling interface 30 is coupled to the differential carrier 110 such that the rotation of the spur ring gear 108, as driven by the spur pinion gear 102, via the electric motor 26, will drive/rotate the differential carrier 110 and the drive axle 100. Hence, the drive axle 100 can be driven/rotated to impart motive force on the vehicle 18 via operation of the ICE 46, via operation of the electric motor 26, or via simultaneous operation of the ICE 46 and the electric motor 26. In various implementations, the electric motor gearing/coupling interface 30 provides approximately a 10:1 reduction ratio such, that differential carrier 110 rotates approximately ten times slower than the electric motor shaft 106.

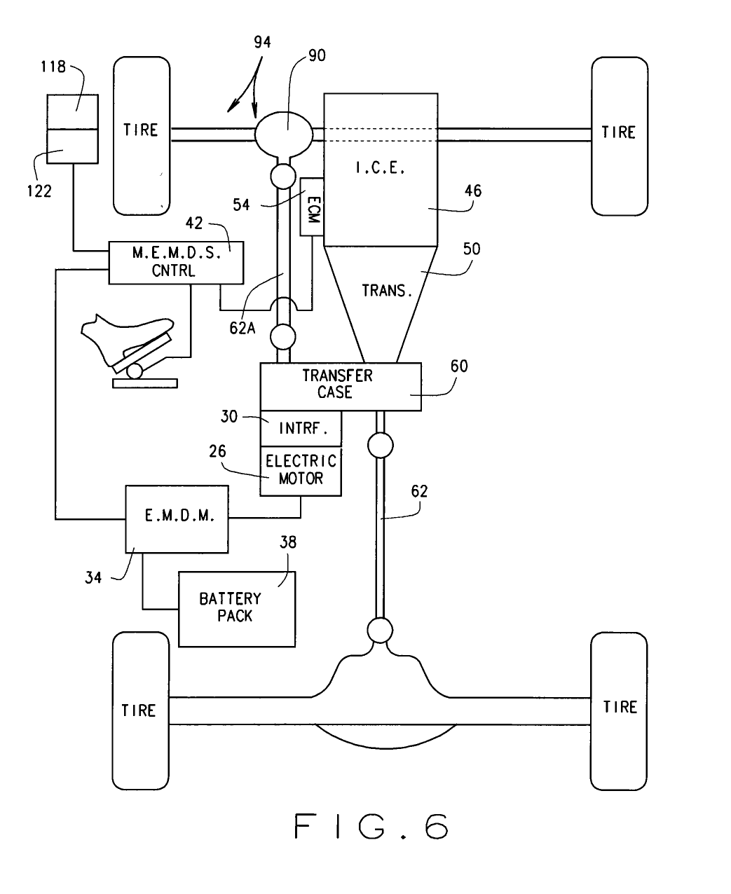

Referring now to FIG. 6, in various embodiments, wherein the vehicle 18 is a 4-wheel drive vehicle, the motor gearing/coupling interface 30 can be mounted to and operably engaged with a modified transfer case 60 with the electric motor 26 mounted to an opposite side of the motor gearing/coupling interface 30. In such embodiments, the motor gearing/coupling interface 30 can include a planetary gear set that is operably engaged the electric motor shaft and a gear set within the transfer case 60. Accordingly, in operation, the electric motor 26 and motor gearing/coupling interface 30 drive the gear set of the transfer case 60, which then distributes power to a transfer case drive shaft 62A and/or the transmission drive shaft 62. In various implementations, the motor gearing/coupling interface 30 provides approximately a 3:1 gear reduction from the electric motor 26 to the transfer case 60.

Accordingly, during operation of the presently disclosed modular electric motor drive system 10, the electric motor 26 is always mounted and ‘in gear’, i.e. the electric motor 26 is always spinning anytime the vehicle 18 is in motion. If electrical power is applied to the electric motor 26 from the battery pack 38, the electric motor 26 operates to assist or replace the motive power provided by the ICE 46 of the vehicle 18. Moreover, when the vehicle 18 coasts, i.e., the ICE 46 is not providing motive power to the vehicle 18, then the electric motor 26 can apply regenerative braking to decelerate the vehicle 18 and can simultaneously function as a generator to recharge the batteries of the battery pack 38.

As described above, in various embodiments, the VFD module includes a transformer/rectifier and or DC link (not shown) for transforming/converting voltage output from the battery pack 38 to a desired voltage input to the electric motor 26. Exemplarily, in such exemplary embodiments, the VFD module 34 (e.g., insulated gate bipolar transistor (IGBT) and transformer) can be structured and operable to have: a DC input voltage to DC Link/transformer/rectifier of approximately 156 V; an AC output voltage range of approximately 0 to 460 V, based on frequency; an output power of 37.3 kW continuous 67.1 kW peak; a weight of approximately 15 lbs; and a heat pipe cooled transformer & drive. However, it should be noted that the above example is merely exemplary and should not be viewed as narrowing the scope of the present disclosure. That is, many types of drives, electric motors and battery technologies, other than IGBTs, electric motors and lead acid batteries, can be implemented in the presently disclosed modular electric motor drive system 10. Also, in various exemplary embodiments, DC to DC links can be used, whereby the voltage will vary based on battery type, capacity, etc.

In various exemplary embodiments, the battery pack 38 can include one or more batteries having 78-cell groups in parallel, wherein each 78-cell group consists of 13 ‘Group 31’ batteries in series for a total of 13 ‘Group 31’ individual batteries required. Additionally, in various embodiments, the battery pack 38 can comprise one or more absorbed glass mat (AGM) lead acid batteries and have a live of 600 deep charge cycles, wherein the battery density is approximately 39 Wh/kg-105 Wh/Liter and the nominal battery pack voltage equals approximately 156 Volt. Furthermore, in various embodiments, the battery pack 38 can have a capacity of approximately 16.73 kWh, not including charging during regenerative braking and the battery pack can be cooled by heat pipe cooling technology. Still further, in various embodiments, the batter pack 38 can have an approximate weight of 945 lbs, approximate dimensions of 9″ tall×12.6″ wide×48″ long (i.e., 5.6 cu.ft.) and cost approximately $800.

Furthermore, in various embodiments, the MEMDS controller 42 can have as its inputs the setting of a manually adjustable electric drive assist and electric drive braking controls 118 and 122 (exemplarily shown in FIG. 6) as well as accelerator and brake pedal positions and/or pressures. The accelerator pedal is generally simply an input device to communicate how much load (i.e., torque) a driver/operator of the vehicle 18 is requesting from the ICE 46 and/or the electric motor 26. The MEMDS controller 42 will combine the input from the brake pedal, the accelerator pedal, the setting of the electric drive assist and braking controls, and a battery state of charge to determine what load the electric motor 26 can output as well as what load is required of the ICE 46. When braking, the MEMDS controller 42 will consider the state of the battery charge, the setting of the electric drive assist and braking controls, and brake pedal pressure. If the state of the battery charge allows, the MEMDS controller 42 will direct the electric motor 26 to provide enough braking to offset the reflected motor inertia. Alternatively, the MEMDS controller 42 can direct the electric motor 26 to provide the maximum regenerative effort based on either what the electric motor VFD module 34 can deliver or what charge the batteries can accept. In various embodiments, the MEMDS controller 42 can utilize a standard Can Bus/SAEJ 1939 Protocol.

As described above, in various embodiments, the modular electric motor drive system 10 can include one or more manually adjustable electric drive assist and/or electric drive braking controls. For example, in various implementations, one or more of the controls can be disposed on a dash of the vehicle 18, wherein a first control is structured and operable to allow the driver to set a desired amount/proportion of electrical motor assist. For example, at 100% assist, the electric motor 26 would deliver a motor maximum capacity power based on battery charge levels, while at 0% assist, the vehicle 18 is utilizing motive power delivered strictly from the ICE 46. Additionally, a second control can be structured and operable to set an amount of regenerative braking the vehicle driver desires. Even when the battery pack requires a charge, controlling the amount of regenerative braking would be convenient because full regenerative braking can cause deceleration of the vehicle 18 to be too severe and not allow the vehicle 18 to coast well.

In various embodiments, the battery pack 38 can be modular such that the battery pack 38 can be charged in the vehicle 18 or be removed and a fully charged replacement battery pack 18 inserted into the vehicle 18. It is envisioned that with an appropriate docking station and battery handling equipment, such battery pack modular replacement can be accomplished in only a few minutes, e.g., five minutes. Thus, in such modular battery pack embodiments, the vehicle 18 can be operated using only the motive power provided by the modular electric motor drive system 10, with only minimal, or no need, to utilize the ICE 46 of the vehicle 18 to provide motive power.

Importantly, the presently disclosed modular electric motor drive system 10 is structured and operates as fully parallel system with the existing internal combustion engine drive system (ICEDS) 14 and drive train 22 of the vehicle 18 such that the ICEDS 14 and drive train 22 are retained. That is, the ICEDS 14 and drive train 22 remain fully operational and the modular electric motor drive system 10 operates in unison and is fully parallel to ICEDS 14 and drive train 22. As described above, the amount of motive power provided by ICE 46 is controlled by the MEMDS controller 42 which accounts for driver preference settings.

In various exemplary embodiments, wherein the vehicle 18 is an SUV or pickup truck, the energy and cost savings calculations and comparisons between a typical ICE powered vehicle and a vehicle having the presently disclosed modular electric motor drive system 10 installed is provided in the table below.

Energy in 1 gallon gasoline = 120,000 BTU = 35.1 kW-hr
Thermal efficiency of gasoline engine and driveline is 20%. This means
that out of every gallon of gasoline burned, only 7.02 kW-hr of
mechanical work is produced.
Current advanced technology ‘Group 31’ AGM carbon foam batteries
deliver 39 W-hr/Kg
945 lbs. battery pack of Group 31 batteries deliver 16.73 kW-hr
Assuming 50% regenerative braking, 16.73 kW-hr of electrical energy will
increase by 50% to provide 25.10 kW-hr of energy for mechanical work
The PHEV and/or EREV electrical system is 90% efficient, so only
22.6 kW-hr is available for mechanical work
Thus, the energy contained in a fully charged battery provides the work
equivalent to 3.20 gallons of gasoline

In such exemplary embodiments, the approximate weight added to the vehicle due to installation of the presently disclosed modular electric motor drive system can be: Battery pack=approximately 945 lbs; a battery box and interconnect cables, etc.=approximately 100 lbs; motor/gearbox/mounting flanges=approximately 115 lbs; and drive, transformer, controller, etc.=approximatly 20 lbs. Thus, in various embodiments, the total weight if the modular electric motor drive system 10 can be approximately 1,180 lbs.

In instances wherein the vehicle is a SUV or truck, this additional weight can be easily accommodated by installing the presently disclosed modular electric motor drive system 10 into a vehicle 18 that has a heavy duty suspension. For example, a Chevrolet 1500 Suburban (i.e. ½ ton Suburban) is rated at 7400 lbs GVWR, while a Chevrolet 2500 Suburban (i.e. ¾ ton Suburban) is rated at 8600 lbs GVWR. Thus, the 2500 series Suburban has an increased payload capacity of 1200 lbs over the 1500 series Suburban. This increased capacity will easily accommodate the weight of the modular electric motor drive system 10. Thus, although the vehicle 18 will weigh more, the 2500 series Suburban with the presently disclosed modular electric motor drive system 10 will have the same people/cargo carrying capacity of a 1500 series Suburban without the presently described modular electric motor drive system 10.

Accordingly, the presently disclosed modular electric motor drive system 10 can provide considerable operating cost savings for the vehicle into which it is installed. For example, in various exemplary embodiments wherein the vehicle 18 is an SUV or pickup truck, when comparing the battery replacement and charging cost to the cost of burning gasoline or diesel fuel, the following estimated values can be applicable. To produce approximately 16.73 kW-hr of work, an ICE can utilize 3.20 gallons of gasoline, which at a cost of $3.00/gallon=$9.60. However, the battery replacement and charging costs to provide 16.73 kW-hr of work can be approximated at $0.11/kW-hr, which equated to approximately $1.84. Thus, the cost savings to produce 16.73 kW-hr of work is approximately $7.76 per battery charge. If one battery pack charge is needed per day (i.e., 365 charges per year), a cost saving of approximately $2,832 per year can be realized. It should be understood that this exemplary cost saving calculation is conservative, and that for larger vehicles 18, the average gasoline/diesel fuel consumption can exceed 3 gallons per day. Additionally, more than one charge per day is possible, such that the cost savings would increase linearly with the number of charges per day.

Although the above exemplary comparison data relates particularly to SUVs and pickup trucks, it should be understood that the presently disclosed modular electric motor drive system 10 is applicable to any size vehicle, e.g., medium duty trucks, heavy duty trucks, buses, military vehicles such as Humvee/HMMWV, or any other suitable vehicle. Hence, a comparison of the battery replacement and charging cost to the cost of burning gasoline or diesel fuel will vary based on the size of the respective vehicle 18.

Furthermore, in various exemplary embodiments, wherein the vehicle is an SUV or pickup truck, it is envisioned that installation of the presently disclosed modular electric motor drive system may qualify for the Federal Government PHEV Tax Credit, e.g. $7,500. Comparatively, the cost of the installation of the presently disclosed modular electric motor drive system can be approximated as follows: the electric motor=approximately $1,000; the drive/transformer=approximately $1,000; the gearbox/axle modification, etc.=approximately $1,500, two battery pack=approximately $1,000 ($800 for batteries, the rest for battery box, cables, etc.); the controller=approximately $100; the battery charger=approximately $500; and labor to install the modular electric motor drive system=approximately $1,800 (30 hours @ $60/hour). Thus, the exemplary parts and labor cost of the modular electric motor drive system can be approximately $6,900. Then, it is reasonable to calculate that the a 20% profit can be added for profit by the business installing the modular electric motor drive system, e.g., $1,380, bring the total exemplary cost of installation of the modular electric motor drive system to approximately $8,280.

However, this installation cost can be readily offset by the tax credit (e.g., $7500), leaving a difference of $780. However, the fuel cost savings, e.g., approximately $2,832 per year, will recuperate the $780 difference in approximately 3 months and provide a $2052 first year savings.

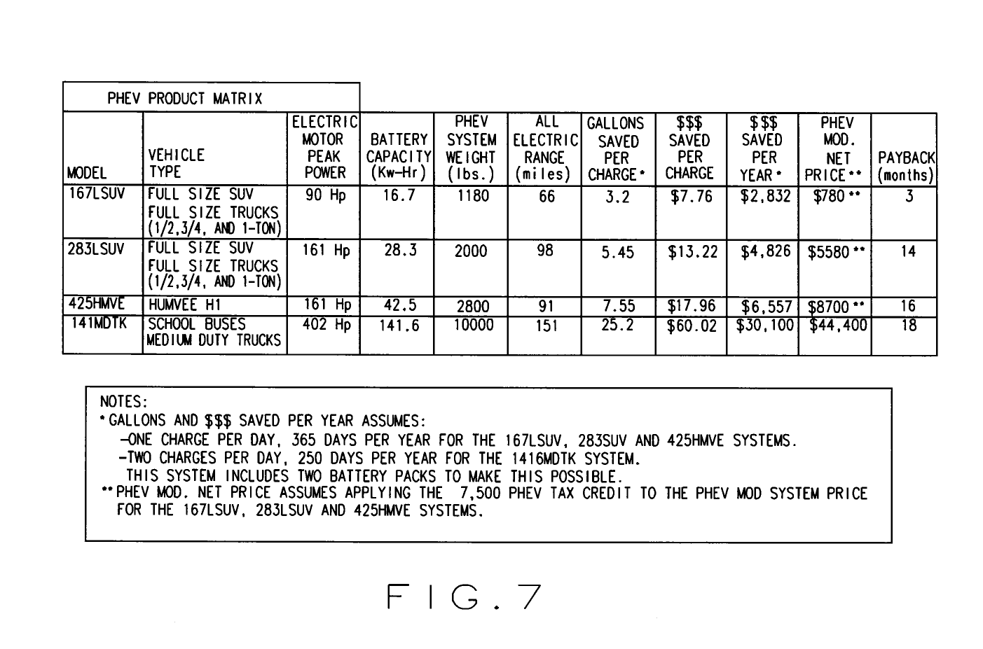

Again, although the above exemplary comparison data relates particularly to SUVs and pickup trucks, it should be understood presently disclosed modular electric motor drive system 10 is applicable to any size vehicle, e.g., medium duty trucks, heavy duty trucks, buses, military vehicle such as Humvee/HMMWV, or any other suitable vehicle. For example, as set forth in the PHEV and/or EREV Product Matrix illustrated in FIG. 7, application of the presently disclosed modular electric motor drive system will provide larger capacities for larger vehicles.

Thus, in various embodiments, the present disclosure provides a modular electric motor drive system 10 that is based on modification of new or existing vehicles while fully retaining the vehicles' original drive trains. That is, the basic platform of the original vehicle 18 is not altered. However, the respective axles can be upgraded to handle increased weight and the respective axle or transmission can be altered to accept the parallel electric power input described herein. Otherwise the vehicle is generally unaltered.

The presently disclosed modular electric motor drive system 10 is designed as fully parallel system, wherein the vehicle original ICEDS 14 and drive train 22 can supply 0% to 100% power, and the brakes can provide 0 to 100% braking, depending on the manually adjustable electric drive assist and/or electric drive braking controls, the MEMDS controller 42 setting and/or the level of driver accelerator/brake activation.

Additionally, in various embodiments, the presently disclosed modular electric motor drive system 10 can be designed to utilize lead acid battery technology. Accordingly, in various embodiments, the presently disclosed modular electric motor drive system 10 is applicable to any vehicle, for example, full size SUVs and trucks, medium and heavy duty trucks, buses, military vehicle, etc., which is counter-intuitive to present hybrid technology and theory. However, in vehicles having the presently disclosed modular electric motor drive system 10 installed, the energy lost due to the weight and size of the converted vehicle is recaptured when the motor goes into ‘regeneration’ mode. Thus, when operating on electric mode, the additional weight is not a disadvantage, but rather an advantage.

As described above, in various embodiments, the features of the presently disclosed modular electric motor drive system 10 include such features as modular battery packs 38 that can provide an infinite all electric range by swapping out battery packs and the retrofittability of the modular electric motor drive system 10 into existing ICE vehicles 18. Either new ICE vehicles or used ICE vehicles can be retrofitted, such that ‘ground up’ new vehicle designs are not required.

Another feature is the fully parallel structure of the presently disclosed modular electric motor drive system 10 and its operation as a load assist system. As disclosed above, the modular electric motor drive system 10 is based on, i.e., in addition to, the primary drive system of the vehicle 18 such that the primary drive system (e.g., the ICEDS 14 and drive train 22) functions as it normally would and the parallel modular electrical motor drive system 10 provides load assist so that the ICE 46 does not have to work as hard nor consume as much fuel.

Also, as set forth above, in various embodiments, the presently disclosed modular electric motor drive system 10 only requires that the differential/axle housing 101, transmission 50, or transfer case 60 of the vehicle 18 be modified and/or the motor gearing/coupling interface 30 (or other suitable gearbox) be mounted to the transmission 50 to accept the electrical power. Additionally, the electric motor 26, battery pack 38 and MEMDS controller 42 must be disposed within the vehicle 18. No other significant vehicle alterations are required. Moreover, the electric motor 26 is always coupled to or engaged with the vehicle drive train 22. That is, the modular electric motor drive system 10 is not structured to decouple or disengage from the vehicle drive train 22 when the modular electric motor drive system 10 is not operating to provide motive power to the vehicle 18. Hence, when load assist or regenerative braking is not required, the electric motor 26 remains engaged with the drive train 22, as described above, and simply spins freely. When the modular electric motor drive system 10 is turned ‘Off’, i.e., the electrical field is removed/neutralized from the stator 82 and rotor 74, the additional motor losses are insignificant.

Additionally, the modular electric motor drive system 10, as disclosed herein, takes advantage of the broad constant torque speed range of the electric motor 26 and eliminates the need to send the electric motor output through a transmission. This simplifies the assembly and makes it more efficient. Particularly, as described above, the electric motor 26 has its own final gearing, i.e., the motor gearing/coupling interface 30, to take full advantage of the broad speed range, which reduces the size of the electric motor 26.

Furthermore, as described above, in various embodiments, integration, or installation, of the presently disclosed modular electric motor drive system 10 involves a gear set, e.g., a planetary gear set, wherein the vehicle transmission 50 or transfer case 60 output is directly connected to the vehicle drive shaft 62/62A via the motor gearing/coupling interface 30. In such embodiments, the ring gear of the planetary gear set is fixed, and the output shaft 62/62A of the transmission 50 or transfer case 60 is disposed within and extends through the hollow shaft 58 of the electric motor 26 that is connected to the sun gear. The electric motor 26 always spins at drive shaft speed, which is related to the vehicle speed, but the ICE speed is independent and controlled by the ICE controller 54 and transmission 50.

Still further, as described above, in various embodiments, the integration, or installation, of the presently disclosed modular electric motor drive system 10 involves a ‘doubly driven differential’, wherein the ring gear is mounted on one side of the differential carrier, much like in a standard differential. The other side of the carrier has a gear mounted to it that meshes with the motor pinion gear. Thus, the electric motor 26 is always spinning at the same rotational speed as the wheels of the vehicle 18, multiplied by the gear ratio. Accordingly, the modular electric motor drive system 10 provides load assist to the ICE 46, but the rotational speed of the electric motor 26 is always related to the vehicle wheel speed.

Still further, as described above, in various embodiments, the integration, or installation, of the presently disclosed modular electric motor drive system 10 involves connecting the electric motor 26 to a planetary gear set which then directly drives the transfer case 60, which in turn drives the drive shaft 62A.

Hence, the modular electric motor drive system 10, as disclosed herein, is based on the primary drive train 22 of the vehicle 18 that provides primary motive power of the vehicle 18 and the parallel modular electric motor drive system 10 is structured and operable to provide load assist to the vehicle ICE 46.

As disclosed above, the modular electric motor drive system 10 has been developed with the following design features:
Designing a modular drive system that can be retrofitted to existing vehicles. Several components are modified (such as the axle/axle housing or transmission/transfer case housing) and several more components are added (such as the electric motor/gearing, motor drive, controller, and battery system). The basic vehicle platform is retained. Current PHEVs and/or EREVs are a ground up design.
Design around existing heavy lead acid battery technology. Although the lead acid batteries are heavy, as the PHEV and/or EREV drive system regenerates energy during braking, this energy is recaptured. Thus, the heavier weight is not disadvantageous. Current PHEV and/or EREV have focused on small vehicles and consequently, focused on light, exotic, power dense batteries.
Designing this modular system around large vehicles (vehicles ranging from being as small as full size SUVs & trucks (class 2 trucks) on up to large class 7 or even class 8 trucks & busses). The wheel/suspension can be easily upgraded to accommodate the additional weight from the PHEV and/or EREV drive & energy storage system. Thus, the modified vehicle can retain its original payload capability even w/the substantially heavy PHEV and/or EREV drive system. Additionally, heavy duty suspension options already exist for these vehicles and do not themselves have to be developed. This same approach can be taken to smaller vehicles (cars and class 1 trucks), but in these applications heavy duty suspensions would have to be developed.
Designing modular battery packs w/quick change out capability. By rapidly changing out the battery pack, the vehicle can be run indefinitely on battery power. Current PHEVs and/or EREVs have the battery pack deeply integrated into the vehicles and quick change out is not possible.
Design the system to provide load assist. The ICE operates as it normally would. The PHEV and/or EREV system assists the internal combustion engine (ICE) thus reducing the load placed upon it. As a result, the fuel consumption of the ICE is reduced. Based on controller settings and driver input, The ICE can provide from 0 to 100% power. In general both the ICE and PHEV and/or EREV system be simultaneously utilized in parallel to share the load. At lease some known current PHEV and/or EREV are series systems and cannot load assist. Once out of battery power these vehicles have not propulsive power. On EREV, the small ICE drives a generator which in turn provides the power for the electric motor. This generator comes on after the battery charge falls below a certain level.
Design the PHEV and/or EREV system to be fully parallel. Either the PHEV and/or EREV or the ICE can fully power the vehicle. Most current PHEV and/or EREV systems are series systems, so the redundancy is eliminated.
Provide regenerative braking capability.

It is envisioned that the presently disclosed modular electric motor drive system 10 can be easily modified to accept lighter, more power dense batteries, such as Lithium-Ion or Nickel-Metal-Hydride, when such batteries become available. Currently, such battery technology is not mature enough to use in vehicles on a production basis and is also cost prohibitive. However, when the advanced battery technology is reliable and cost effective, such batteries can easily and readily be utilized in the presently disclosed modular electric motor drive system 10, as described above. It is further envisioned, as set forth above, that the modular electric motor drive system 10 disclosed herein is applicable to many different size vehicles, for example, SUVs or pickup trucks, medium duty trucks, heavy duty trucks, buses, military vehicle such as Humvee/HMMWV, or any other vehicle.

Furthermore, in various embodiments, the modular electric motor drive system 10 of the present disclosure includes a software control module, i.e., the MEMDS controller 42, that will seamlessly integrate with the engine control module (ECM) 54 and/or the vehicle control module (VCM) (not shown) of the respective vehicle 18.

Typically, vehicles, such as vehicle 18, have an ECM 54 computers that is operable to manage engine power, emissions and additionally have a VCM computer to interface with ECM and all the other electronically controlled systems and devices of the vehicle.

The presently disclosed modular electric motor drive system 10 includes software modularity and compatibility that will broaden the potential retrofit platforms and lessen the scope of modification necessary to interface with the existing equipment of the respective vehicle 18.

For example, many vehicle systems today have a SAE-J1939 CANbus interface between the ECM, accelerator, transmission and the instrumentation package. The presently disclosed modular electric motor drive system 10 can be configured to interface with the existing CANbus system providing software modularity to the retrofit. The MEMDS controller 42 of the presently disclosed modular electric motor drive system 10 will collect inputs from the existing system via CANbus and integrate those inputs with operator inputs and inputs from the presently disclosed modular electric motor drive system 10 to provide the desired performance. The presently disclosed modular electric motor drive system 10 software modularity adds inputs to the existing vehicle control system to parallel and enhance the existing vehicle drive system. While the presently disclosed modular electric motor drive system 10 software controls the parallel hybrid system, the presently disclosed modular electric motor drive system 10 software also provides software inputs to the existing vehicle control system. By providing a fully parallel system operating on operator inputs, the presently disclosed modular electric motor drive system 10 software provides the level of power and control associated with each of the parallel systems.

Operator inputs can include existing vehicle controls such as accelerator, transmission, engine, and brakes from the existing vehicle system. From the presently disclosed modular electric motor drive system 10 operator inputs, the control software directs the level of power assist, brake assist and synchronization with the existing vehicle systems. The operator may select the level of assist ranging from ‘Off’, to a low percentage of assist, to a high percentage of assist including full ‘On’ during which the normal ICE system is disabled. This allows the operator to drive the vehicle on full electric or full internal combustion.

The description herein is merely exemplary in nature and, thus, variations that do not depart from the gist of that which is described are intended to be within the scope of the teachings. Such variations are not to be regarded as a departure from the spirit and scope of the teachings.

1. A modular electric motor drive system for a vehicle having an internal combustion engine, said system comprising:
an electric motor;
a motor gearing/coupling interface operably connected to the electric motor; and
a modular electric motor drive system operable to control operation of the electric motor.
